(19) United States
(12) Patent Application Publication
(10) Pub. No.: US 2016/0225023 A1
(43) Pub. Date: Aug. 4, 2016

(54) METHOD AND APPARATUS FOR PROVIDING TARGETED VIDEOS TO USER

(71) Applicants: TECHNICOLOR (CHINA) TECHNOLOGY CO., LTD., Beijing (CN); THOMSON LICENSING, Issy-Less-Moulineaux (FR)

(72) Inventors: Yanfeng ZHANG, Bejing (CN); Yuntao SHI, Bejing (CN); Zhigang ZHANG, Beijing (CN)

(21) Appl. No.: 15/024,820

(22) PCT Filed: Sep. 26, 2013
(86) PCT No.: PCT/CN2013/084328

§ 371 Date: Mar. 24, 2016

(51) Int. Cl. G06Q 30/02

(52) U.S. Cl. CPC G06Q 30/0255

(57) ABSTRACT

A method and an apparatus for providing targeted videos are provided. The method comprises transmitting the videos to the user in accordance with the assigned priorities calculated by a matching result between at least one keyword of the browsing history of the user for at least one online shopping website and at least one keyword of the text information from the videos based on a commodity category list.

### TECHNICAL FIELD

The present invention generally relates to the targeted advertising. In particular, the present invention relates to a method and apparatus for providing targeted videos to a user.

### BACKGROUND

Advertising plays an important role on linking consumer's purchase to advertised products. It can be appreciated therefore that advertisers want to reach as many consumers as efficiently as possible.

An advertisement on consumers may have three kinds of effects: the first one is to build or arise consumer's purchase intention; the second one is to boost brand fame and to make the product well known; and the third one is to enhance consumer's purchase intention. The first and the second effects heavily depend on the attractive capability of the advertisement itself. This will be decided by many factors, which may for example involves the design of an advertisement, the advertising media, and the spreading extention of an advertisement, etc.

As for the third effect, it will be good for the advertisers to understand how customers' minds work in order to learn or predict the consumer's purchase intention. And then an advertisement system can use such knowledge to provide suitable advertisements to a consumer. Targeted advertising was developed for such a purpose, which is a type of advertising whereby advertisements are placed so as to reach consumers based on various traits such as demographics, psychographics, behavioral variables, etc. The above-mentioned behavioral variable may comprise a product purchase history of a consumer.

The targeted advertising for online shopping may involve transmission of videos relevant to a product or a service to a consumer over the Internet. According to online statistics, “streaming video delivers nearly three times higher brand awareness and message association, and more than 100% higher purchase intent and online ad awareness than non-rich media ads.” Video advertisements can provide a testimonial and demonstrate the relevant product or service in a compelling, easy to understand way. In order to improve the relevancy of the video to the product or service which a consumer is interested in and would like to purchase, it is important to analyse and determine the purchase intention of the consumer.

Some known targeted advertising system for online shopping can learn the purchase intention of consumers by mining their web browsing histories or topics in social networks. However, the problem with such kind of approach is that there may not be a very strong correlation between purchase intentions and web browsing/social network histories. It can be appreciated that there are many different reasons for a user to browse a web site or join a social network, for example, for fun, for learning some knowledge, or just for killing time (all of them are not purchase-related).

### SUMMARY

In view of the above problem in the conventional technologies, a method and an apparatus for providing targeted videos to a user are provided.

According to one aspect of the invention, a method for transmitting videos to a user is provided. The method comprises: transmitting the videos to the user in accordance with the assigned priorities calculated by a matching result between at least one keyword of the browsing history of the user for at least one online shopping website and at least one keyword of the text information from the videos based on a commodity category list.

According to one aspect of the invention, an apparatus for transmitting videos to a user is provided. The apparatus comprises: means for obtaining the browsing history of the user for at least one online shopping website; means for obtaining at least one keyword from the browsing history of the user for at least one online shopping website; means for obtaining at least one keyword of text information from a plurality of videos; means for matching the at least one keyword of the browsing history and the at least one keyword of the text information from the plurality of videos based on a commodity category list and assigning a priority to each video based on a weighting factor calculated from the matching results; and means for transmitting the videos to the user in accordance with the assigned priorities.

It is to be understood that more aspects and advantages of the invention will be found in the following detailed description of the present invention.

### BRIEF DESCRIPTION OF THE DRAWINGS

The accompanying drawings are included to provide further understanding of the embodiments of the invention together with the description which serves to explain the principle of the embodiments. The invention is not limited to the embodiments.

In the drawings:

FIG. 1 is an exemplary diagram showing the architecture of a targeted video advertisement system according to an embodiment of the invention;

FIG. 2 is an exemplary diagram showing a part of a webpage;

FIG. 3 is an exemplary diagram showing the extraction of nouns from a sentence as keyword information;

FIG. 4 is an exemplary diagram showing a list of commodity categories of Ebay;

FIG. 5 is an exemplary diagram showing a commodity-subcategory-category tree built with the extracted keyword information; and

FIG. 6 is a flow chart showing a method for providing targeted video advertisement to a user according to an embodiment of the invention.

### DETAILED DESCRIPTION

An embodiment of the present invention will now be described in detail in conjunction with the drawings. In the following description, some detailed descriptions of known functions and configurations may be omitted for conciseness.

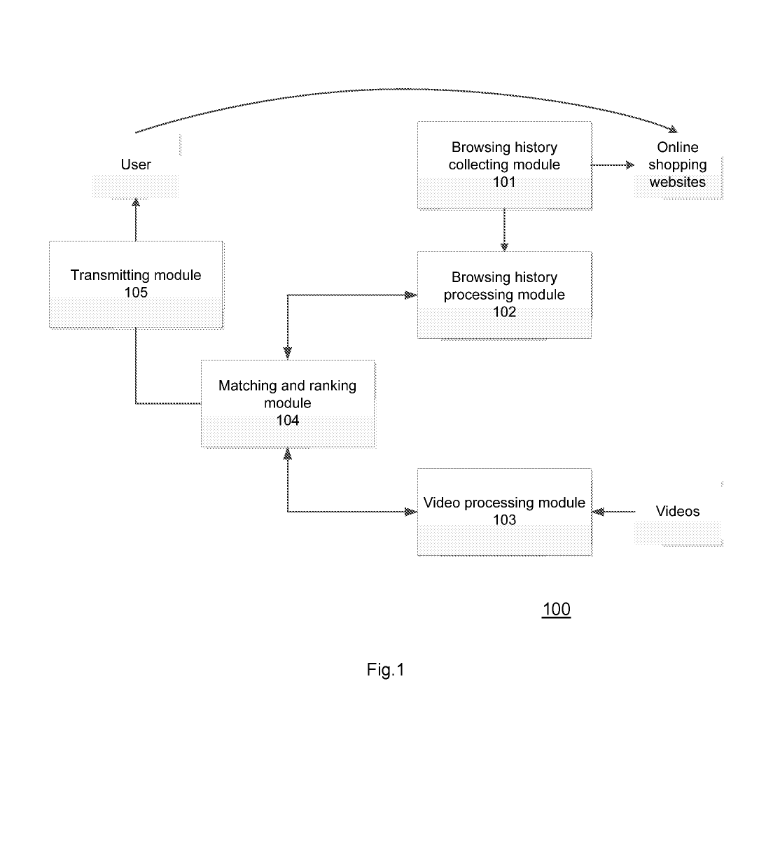

FIG. 1 is an exemplary diagram showing the architecture of a targeted video advertisement system according to an embodiment of the invention.

As shown in FIG. 1, the system 100 comprises a browsing history collecting module 101 for collecting and storing the browsing history of a user for at least one online shopping websites.

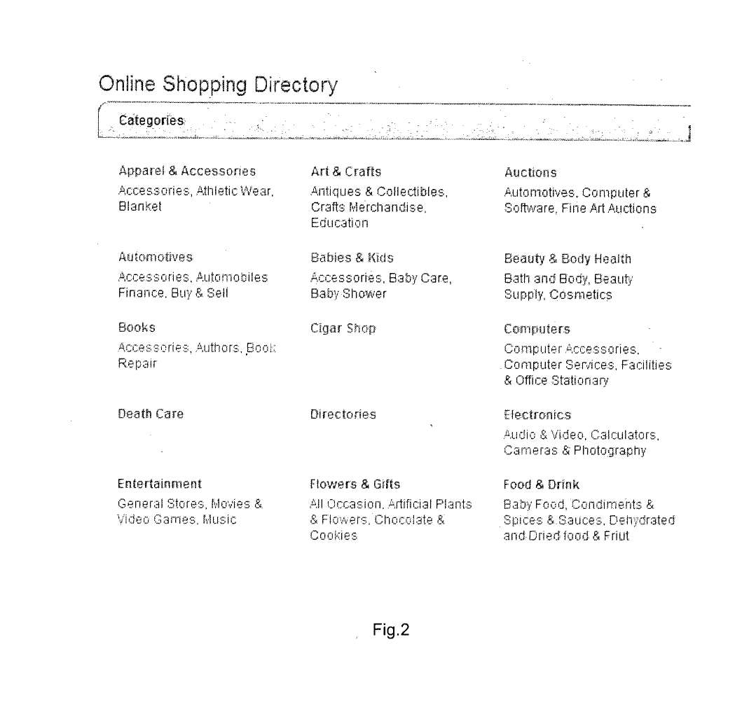

When a consumer browses an online shopping website, such as Amazon or EBay, the browsing history can be obtained. The directory of web URL (Universal Resource Location) addresses of the browsed online shopping websites can be manually inputted, automatically judged by computer, or retrieved from Internet directory. For example, most online shopping websites can be retrieved and recorded by parsing the webpage http://www.onlinestorelist.com/. FIG. 2 is an exemplary diagram showing a part of the above webpage. A crawler can be designed, which crawls the contents from the links and filters the contents with a regular expression to obtain all URL addresses. Other technologies for obtaining the browsing history of a user can also be used.

As an example, the browsing history collecting module 101 can comprise plug-in agents installed in the web browser of the user or sniffers installed in the home gateway of the user for obtaining the browsing history of the user. The data of the browsing history can be stored in the browsing history collecting module 101 with any appropriate format.

It can be appreciated that raw words and user data may also be executed by information extraction and saved in the a browsing history collecting module 101. The raw words and the user data may be implemented by tagging and filtering process. After that, such raw data and user words will not be used again and can be removed from the browsing history collecting module 101.

It should be noted that since only some keywords and corresponding category information (to be described below) obtained from the browsing history will be used by the targeted video advertisement system 100, the privacy of the web browsing of the user will not be invaded.

The system 100 comprises a browsing history processing module 102 for obtaining keywords from the browsing history of the user collected and stored by the browsing history collecting module 101.

The browsing history processing module 102 will firstly collect text information from the browsing history obtained and stored by the browsing history collecting module 101.

Then keywords are extracted from the text information collected from the browsing history. The browsing history obtained and stored by the browsing history collecting module 101 (for example, the plug-in agents or sniffers) may comprises irrelevant text information in terms of the determination of the user's purchase intention. Such irrelevant text information may comprise advertisment, image tags, formatting, fonts, styles, comments, JScript and VBScript, forms, frames, and meta tags etc. In order to extract proper keyword information which reflects the purchase intension of the user, the browsing history processing module 102 may perform a filtering process to remove the irrelevant information as much as possible. Then keywords are extracted from the pruned web content.

As for the keyword information extraction, a noun is preferable since it is believed to contain the most information about a web page. In the following description, an example of nouns being extracted as keywords will be described.

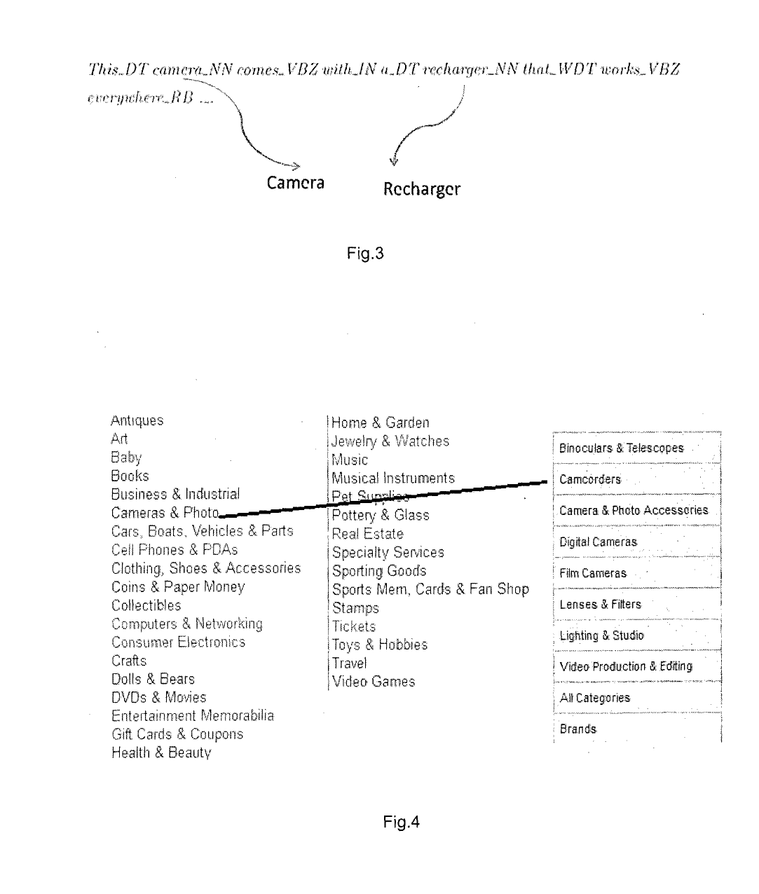

FIG. 3 is an exemplary diagram showing the extraction of nouns from a sentence as keyword information. As shown in FIG. 3, each word in a sentence can be tagged with word level tags used in natural language processing. The meanings of the word level tags used in FIG. 3 are as below:

DT: determiner;

NN: noun;

VBZ: Verb, 3rd person singular present;

IN: Preposition or subordinating conjunction;

WDT: Wh-determiner;

RB:adverb and the two nouns.

As shown in FIG. 3, two nouns, “camera” and “recharger”, are extracted as keywords with the keyword information extraction.

In this embodiment, the browsing history processing module 102 can also generate a mapping relationship between each one of the extracted keywords and a commodity category list, for purpose of the keyword matching process which will be described later.

It can be appreciated that an online shopping website may maintain a list of commodity categories. Each category in the list may further comprise one or more levels of sub-categories. That is, the commodity category list may be in a hierarchical structure. The above mentioned crawler can crawl the commodity category list from online shopping websites. FIG. 4 is an exemplary diagram showing a list of commodity categories of Ebay. As shown in FIG. 4, the “camera & photo” category is in the commodity category list, which comprises a list of sub-categories. In the example shown in FIG. 4, for the simplicity of the illustration, the “camera & photo” category only has one level of sub-categories. But it can be appreciated that one or more of the sub-categories can have one or more levels of further sub-categories. When a user browses a commodity on an online shopping website, the category to which the browsed commodity belongs may be presented in the webpage. In this embodiment, the commodity category list is obtained from Ebay, one of the online shopping websites in the browsing history of the user. The commodity category list can also be obtained by integrating the crawled lists from a plurality of online shopping websites according to a predetermined integration algorithm. It should be noted that the commodity category list can also be preset independent of any commodity category lists of the plurality of online shopping websites.

By parsing the nouns contained in a webpage and the commodity categories presented on this page, a noun-category mapping list for a single web page can be built, as illustrated in the table 1 below. In the table 1, the last column shows the frequency of occurrences of a noun mapped to the commodity category list.

TABLE 1
noun-category mapping list

| Category | Sub-category | Nouns | frequency |
|---|---|---|---|
| Camera & photo | Digital cameras | picture | 16 |
| | | camera | 25 |
| | | movie | 9 |
| | | lens | 8 |
| | | shutter | 11 |
| | | screen | 4 |
| | | . . . | . . . |

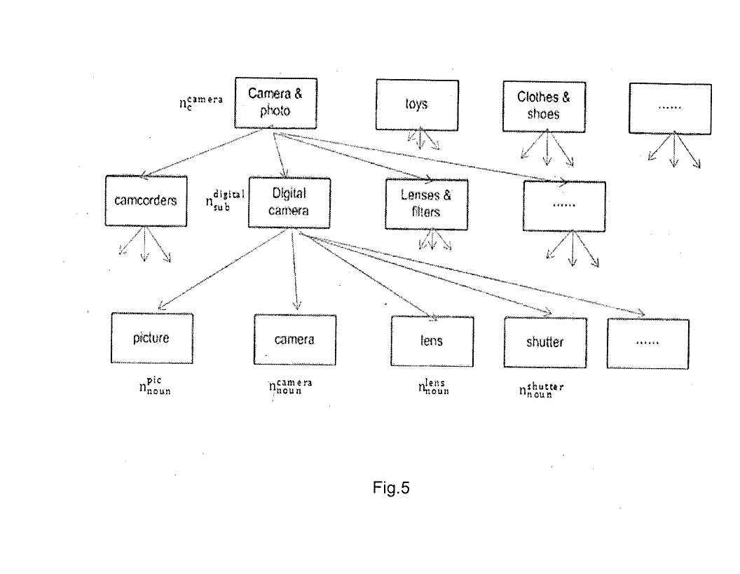

The keywords can also be extracted from the browsing history on online shopping websites aggregated for a determined time period, such as several days or a week. The extracted keyword information can be built as a commodity-subcategory-category tree. An example of the commodity-subcategory-category tree is shown in FIG. 5. The numbers “n^{x}_{y}” beside some categories, sub-categories and keywords present the frequencies of the corresponding categories, sub-categories and keywords.

Please refer back to FIG. 1. The system 100 further comprises a video processing module 103 for obtaining keywords of text information from a video. In this embodiment, the video is an advertisement in video format for online shopping. The advertisement in video format may include but is not limited to a video from different sources, e.g., from websites or webpages, as well as streaming videos.

The video processing module 103 will firstly obtain text information from the video advertisement. Several known methods can be used to obtain text information from a video. Optical character recognition (OCR) technology is an known approach to convert scanned images into machine-encoded text. Speech-to-text technology, such as Hidden Markov Model (HMM), Dynamic time warping (DTW), can be used to obtain text information from voice data of the video. Any appropriate technologies can be used in this respect and no further details will be provided.

The producer of an advertisement video may append text-based metadata or annotation to the corresponding video clips. From these text information for a certain video advertisement, keywords and their frequencies are retrieved to form a “bag of words” about the video clips. Here nouns are preferable keywords since nouns are believed to contain the most information of a video clip, as mentioned above.

Then the video processing module 103 will determine the meaning or sense of an extracted noun from the video. It can be appreciated that the extracted nouns may have different meanings or senses. There may exist ambiguity about how they are interpreted. With several interpretation possibility, a noun can be mapped to several categories. For example, from the sentence—“when shooting video, the sensor serves itself as an electronic shutter (much like compact digital cameras with no physical shutter) time is controlled via the same sensor.”, the noun—“shutter” can be extracted as a noun. Without considering the context words around the noun—“shutter”, shutter can have several meanings:

1. One that shuts, as:

2. A hinged cover or screen for a window, usually fitted with louvers.

3. A mechanical device of a camera that controls the duration of a photographic exposure, as by opening and closing to allow light coming through the lens to expose a plate or film.

4. The movable louvers on a pipe organ, controlled by pedals, that open and close the swell box.

The meaning or sense of a noun can be determined by looking at the context of the noun. The context of a word, or a window around the word, can be interpreted as the size of words surrounding this word, e.g. a fixed numbers of nouns and verbs, the paragraph in which a word locates. With the sentence in the bold example and online reference resources, such as WordNet® (wordnet.princeton.edu), the meaning of the noun—“shutter” can be uniquely determined and its ambiguation can be eliminated. WordNet® is a large lexical database of English. Nouns, verbs, adjectives and adverbs are grouped into sets of cognitive synonyms (synsets), each expressing a distinct concept. Synsets are interlinked by means of conceptual-semantic and lexical relations. The resulting network of meaningfully related words and concepts can be navigated with the browser. WordNet® is also freely and publicly available for download. WordNet's structure makes it a useful tool for computational linguistics and natural language processing. WordNet® superficially resembles a thesaurus, in that it groups words together based on their meanings. However, there are some important distinctions. First, WordNet® interlinks not just word forms—strings of letters—but specific senses of words. As a result, words that are found in close proximity to one another in the network are semantically disambiguated. Second, WordNet labels the semantic relations among words, whereas the groupings of words in a thesaurus does not follow any explicit pattern other than meaning similarity.

After the text extraction and meaning determination (ambiguity elimination might be needed) of the extracted text, a mapping relationship will be generated between the extracted keywords and the commodity category list.

In this embodiment, the sub-category and category of the noun—“shutter” can be obtained with the commodity category list as shown in FIG. 4.

It can be appreciated, if more than one keywords are extracted from the video, a commodity-subcategory-category tree similar to FIG. 5 can be built for each advertisement video.

The system 100 comprises a matching and ranking module 104 for assigning a priority to each video advertisement in the library by a matching result between keywords of the browsing history of the user for the online shopping websites and keywords of the text information from the videos based on the commodity category list.

The above matching can be determined by a same category structure for a keyword from the browsing history of the user and a keyword of text information from a video advertisement based on the commodity category list. That is, if the keyword of text information from a video has the same category, sub-category, and further sub-category(if any) as the keyword from the browsing history of the user based on the commodity category list, it is considered that a matching result is obtained for this video and the browsing history in terms of these keywords.

In this embodiment, two keywords, “camera” and “recharger”, are extracted from the browsing history of the user, wherein the keyword “camera” is in the category of “Camera & Photo” and the sub-category of “Digital cameras”. The keyword “shutter” extracted from the video advertisement is in the same category and the same sub-category. Here, the keyword “camera” from the browsing history and the keyword “shutter” from the video advertisement has a same category structure based on the commodity category list. A matching result is obtained then.

In this embodiment, nouns are extracted as keywords for both the browsing history of the user and the video advertisement. And a noun-category mapping list is built respectively for the browsing history of the user and the video advertisement, as shown in the table 1. It can be appreciated that these two list reflect the category structure of respective keywords and a comparison of the two lists can facilitate the determination of the matching process.

A weighting factor can be calculated from the matching results. Any appropriate mechanism for assigning a weight value to a keyword can be used. For example, if a matching result is obtained, a weight value “1” can be assigned to a keyword. If there is a matching result for a keyword of a video advertisement in terms of the category structure, the weight value can be determined by the frequency of the keyword in the video advertisement tree and the frequency of the corresponding keyword in the browsing history tree. If the meaning of a keyword of a video advertisement is also the same as the keyword of the browsing history, the sum of two above frequencies can be calculated as the weight value of this keyword for the video advertisement. After the weight values of all extracted keywords are calculated for a video advertisement, the total weight value of the video advertisement can be calculated by summing up the weight values of all the keywords. For example, if the frequency of “camera” in the browsing history is 8, and the frequency of “camera (or a keyword with similar meaning)” in an advertisement video is 6, then the weight for “camera” is 8+6=14.

A priority is assigned to a video advertisement based on the calculated weight value.

The system 100 comprises a transmitting module 105 for transmitting the video advertisements to the user in accordance with the priority assigned by the matching and ranking module 104.

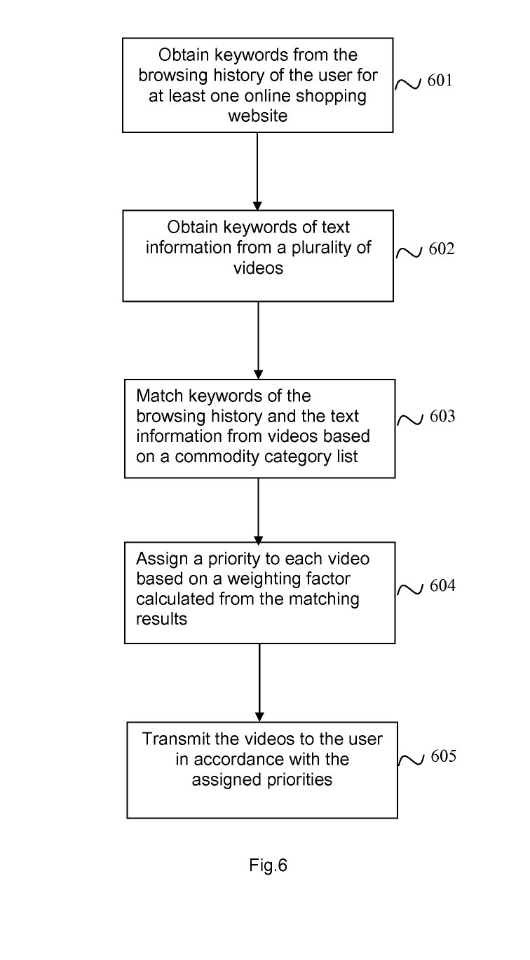

FIG. 6 is a flow chart showing a method for providing a targeted video to a user according to an embodiment of the invention.

At step 601, it obtains keywords from the browsing history of the user for at least one online shopping website.

At step 602, it obtains keywords of text information from a plurality of videos.

At step 603, it matches keywords of the browsing history and keywords of the text information from the plurality of videos based on the commodity category list.

At step 604, it assigns a priority to each video based on a weighting factor calculated from the matching results.

At step 605, it transmits the videos to the user in accordance with the assigned priorities.

It is to be understood that the present invention may be implemented in various forms of hardware, software, firmware, special purpose processors, or a combination thereof. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

1. An apparatus for transmitting a plurality of videos to a device, comprising a processor configured to:
obtain at least one keyword from a browsing history on the device for at least one website providing commodities;
obtain at least one keyword of text information from each video of said plurality;
match the at least one keyword of the browsing history and the at least one keyword of the text information from each video of said plurality based on a hierarchical structure of a commodity category list and for assigning a priority to said video based on a weighting factor calculated from the matching results; and
transmit videos of said plurality to the device in an order of transmission of each video based on its assigned priority.

2. Apparatus according to claim 1, wherein the processor is further configured to obtain the browsing history for at least one website and receives the browsing history from a plug-in agent installed in the web browser on the device.

3. Apparatus according to claim 1, wherein the processor is further configured to obtain the browsing history for at least one website using a sniffer installed in the apparatus.

4. Apparatus according to claim 1, wherein the commodity category list is obtained from one of the at least one website.

5. Apparatus according to claim 1, wherein the commodity category list is obtained by integrating at least one commodity category lists of the at least one website.

6. Apparatus according to claim 1, wherein the commodity category list is set independent of the commodity category lists of the at least one website.

7. Apparatus according to claim 1, wherein the processor is further configured to obtain at least one keyword from the browsing history for at least one website and extract a noun as the at least one keyword.

8. Apparatus according to claim 1, wherein the matching is determined by a same hierarchical structure based on the commodity category list for a keyword of the browsing history and a keyword of text information from a video.

9. Apparatus according to claim 1, wherein the weighting factor is calculated as a function of frequencies of a matched keyword of the browsing history and the text information from a video.

10. Apparatus according to claim 9, wherein the weighting factor is calculated as a sum of frequencies of a matched keyword of the browsing history and the text information from a video with the same meaning.

11. Apparatus according to claim 1, wherein the video is an advertisement in video format.

12. Apparatus according to claim 11, wherein the advertisement in video format is from a website, a webpage, or a streaming video.

13. A method for transmitting videos to a device, comprising:
transmitting the videos to the device in accordance with the assigned priorities calculated by a matching result between at least one keyword of a browsing history on the device for at least one website providing commodities and at least one keyword of text information from the videos based on a hierarchical structure of a commodity category list.

14. Method for transmitting a plurality of videos to a device comprising:
obtaining at least one keyword from the browsing history on the device for at least one website providing commodities;
obtaining at least one keyword of text information from each video of said plurality;
matching the at least one keyword of the browsing history and the at least one keyword of the text information from each video of said plurality based on a hierarchical structure of a commodity category list;
assigning a priority to each video of said plurality based on a weighting factor calculated from the matching results obtained for this video; and
transmitting the videos to the device in an order of transmission of each video based on its assigned priorities.
